(19) United States
(12) Patent Application Publication
(10) Pub. No.: US 2021/0319766 A1
(43) Pub. Date: Oct. 14, 2021

(54) ILLUMINATION OF A PORTION OF A DISPLAY OF A COMPUTING DEVICE

(71) Applicant: Micron Technology, Inc., Boise, ID (US)

(72) Inventor: Carla L. Christensen, Boise, ID (US)

(21) Appl. No.: 16/843,531

(22) Filed: Apr. 8, 2020

(51) Int. Cl. G09G 5/10

(52) U.S. Cl. CPC G09G 5/10; G09G 2330/02; G09G 2358/00; G09G 2320/0686; G09G 2354/00

(57) ABSTRACT

Methods, apparatuses, and non-transitory machine-readable media illumination of a portion of a display of a computing device are described. Apparatuses can include a display, a memory device, and a controller. In an example, the controller can determine an active portion of the display and in response, illuminate the active portion while an inactive portion of the display remains unilluminated. In another example, a method can include the controller receiving a request to illuminate a portion of the display, and in response, illuminating the portion of the display while a remaining portion of the display remains unilluminated. The request can be received via a touchscreen display of a mobile device in an example.

### TECHNICAL FIELD

The present disclosure relates generally to apparatuses, non-transitory machine-readable media, and methods for illumination of a portion of a display of a computing device.

### BACKGROUND

A computing device is a mechanical or electrical device that transmits or modifies energy to perform or assist in the performance of human tasks. Examples include thin clients, personal computers, printing devices, laptops, mobile devices (e.g., e-readers, tablets, smartphones, etc.), internet-of-things (IoT) enabled devices, and gaming consoles, among others. An IoT enabled device can refer to a device embedded with electronics, software, sensors, actuators, and/or network connectivity which enable such devices to connect to a network and/or exchange data. Examples of IoT enabled devices include mobile phones, smartphones, tablets, phablets, computing devices, implantable devices, vehicles, home appliances, smart home devices, monitoring devices, wearable devices, devices enabling intelligent shopping systems, among other cyber-physical systems.

A computing device can include a display used to view images or text. The display can be a touchscreen display that serves as an input device. When a touchscreen display is touched by a finger, digital pen (e.g., stylus), or other input mechanism, associated data can be received by the computing device for. The touchscreen display may include pictures and/or words, among others that a user can touch to interact with the device.

### BRIEF DESCRIPTION OF THE DRAWINGS

FIG. 1 is a functional block diagram in the form of a computing system including an apparatus having a display, a memory device, and a controller in accordance with a number of embodiments of the present disclosure.

FIG. 2 is a diagram representing an example of illumination of a portion of a display of a computing device in accordance with a number of embodiments of the present disclosure.

FIG. 3 is another diagram representing an example of illumination of a portion of a display of a computing device in accordance with a number of embodiments of the present disclosure.

FIG. 4 is a functional diagram representing a processing resource in communication with a memory resource having instructions written thereon for illumination of a portion of a display of a computing device in accordance with a number of embodiments of the present disclosure.

FIG. 5 is a flow diagram representing an example method for illumination of a portion of a display of a computing device in accordance with a number of embodiments of the present disclosure.

### DETAILED DESCRIPTION

Apparatuses, machine-readable media, and methods related to illuminating a portion of a display of a computing device are described. Computing device displays (e.g., monitors, mobile device screens, laptop screens, touchscreens, etc.) can be illuminated (e.g., backlit) to improve readability and viewing of the images or text on the display. For instance, when a user is browsing the Internet on his or her smartphone, working on a laptop, or reading on an e-reading device the display is illuminated to improve user experience (e.g., reading in sunlight, ease in viewing images, etc.).

However, illumination of the display can be disruptive and/or undesired, for instance when a user is in a dark room. The user may be concerned about disrupting others in the room (e.g., a sleeping baby, others watching a movie) or may desire to view only portion of the display. For instance, a user reading on an e-reader device may desire only the upper half of the display to be illuminated to reduce disruption to a sleeping spouse. Users may also desire privacy based on the content of the text or images on the display (e.g., bank statements, passwords, security images, etc.). Additionally, illuminating an entire display can increase power consumption by the computing device and decrease battery life.

Some approaches to easing light disruption include dimming the illumination of the screen. However, this can reduce the readability and viewing of images or texts on the display, as they may be difficult to see as low levels.

Examples of the present disclosure can ease disruption, protect privacy, reduce power consumption by the computing device, and increase battery life of the computing device by illuminating only a portion of the display designated by a user and/or determined to be an active portion of the display. For instance, examples can include a method for illuminating a portion of a display of a computing device including receiving signaling via a touchscreen that indicates a portion of the touchscreen to be illuminated and identifying a light emitting source for each pixel bounded by the portion of the touchscreen indicated by the signaling. The method can include providing power to each identified light emitting source within the portion and removing power from or refraining from providing power to light emitting sources outside the portion.

Other examples of the present disclosure can include an apparatus including a display, a memory device, and a controller coupled to the memory device configured to determine an active portion of the display and illuminate, responsive to the determination, the active portion of the display while an inactive portion of the display remains unilluminated. As used herein, an “apparatus” can refer to, but is not limited to, any of a variety of structures or combinations of structures, such as a circuit or circuitry, a die or dice, a module or modules, a device or devices, or a system or systems, for example.

Yet other examples of the present disclosure an include a non-transitory machine-readable medium comprising a processing resource in communication with a memory resource having instructions executable by the processing resource to receive a touch request via a touchscreen display of a mobile device to illuminate a portion of the touchscreen display. The instructions can be executable to illuminate the portion of the touchscreen display while a remaining portion of the touchscreen display remains unilluminated.

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

As used herein, designators such as “N,” etc., particularly with respect to reference numerals in the drawings, indicate that a number of the particular feature so designation can be included. It is also to be understood that the terminology used herein is for the purpose of describing particular embodiments only and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context. The terms “data” and “data values” are used interchangeably herein and can have the same meaning, as appropriate to the context.

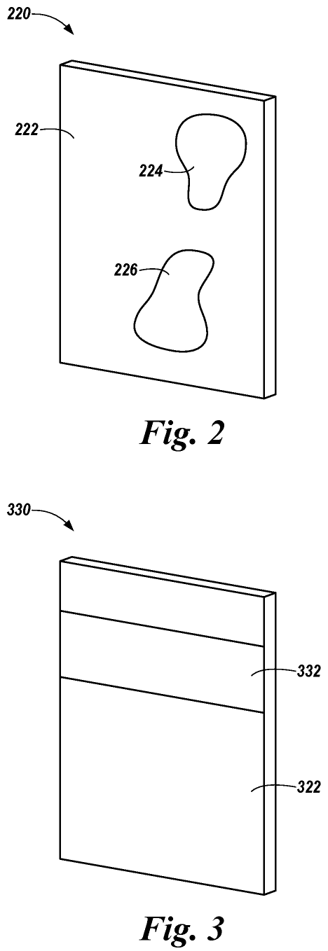

The figures herein follow a numbering convention in which the first digit or digits correspond to the figure number and the remaining digits identify an element or component in the figure. Similar elements or components between different figures can be identified by the use of similar digits. For example, 222 can reference element “22” in FIG. 2, and a similar element can be referenced as 322 in FIG. 3. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

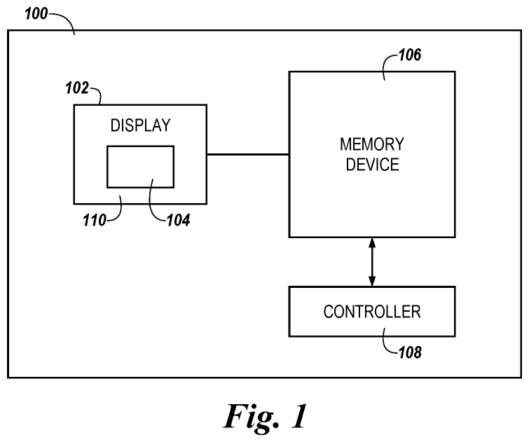

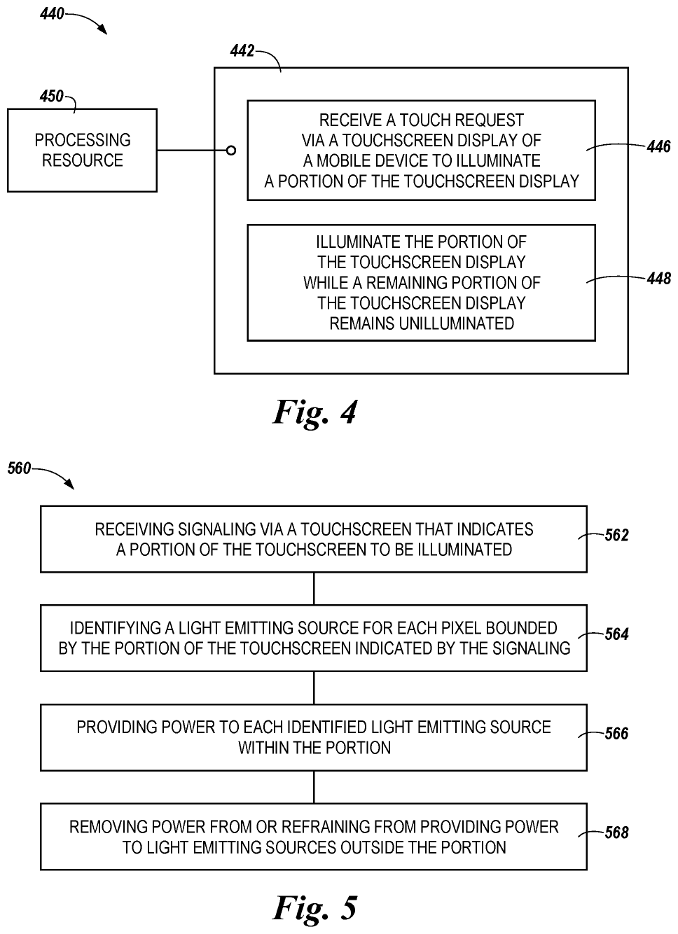

FIG. 1 is a functional block diagram in the form of a computing system including an apparatus 100 having a display 102, a memory device 106, and a controller 108 (e.g., a processor, control circuitry, hardware, firmware, and/or software) in accordance with a number of embodiments of the present disclosure. The memory device 106, in some embodiments, can include a non-transitory MRM, and/or can be analogous to the memory device 442 described with respect to FIG. 4. The apparatus 100 can be a computing device; for instance, the display 102 may be a touchscreen display of a mobile device such as a smartphone. The controller 108 can be communicatively coupled to the memory device 106 and/or the display 102. As used herein, “communicatively coupled” can include coupled via various wired and/or wireless connections between devices such that data can be transferred in various directions between the devices. The coupling need not be a direct connection, and in some examples, can be an indirect connection.

The memory device 106 can include non-volatile or volatile memory. For example, non-volatile memory can provide persistent data by retaining written data when not powered, and non-volatile memory types can include NAND flash memory, NOR flash memory, read only memory (ROM), Electrically Erasable Programmable ROM (EEPROM), Erasable Programmable ROM (EPROM), and Storage Class Memory (SCM) that can include resistance variable memory, such as phase change random access memory (PCRAM), three-dimensional cross-point memory (e.g., 3D XPoint™), resistive random access memory (RRAM), ferroelectric random access memory (FeRAM), magnetoresistive random access memory (MRAM), and programmable conductive memory, among other types of memory. Volatile memory can require power to maintain its data and can include random-access memory (RAM), dynamic random-access memory (DRAM), and static random access memory (SRAM), among others.

The controller 108 can receive a request to illuminate a portion 104 of the display 102, and can illuminate that portion 104, while a remaining portion 110 remains unilluminated. For instance, a user may select via a menu (e.g., a “settings” menu, a “display” menu, etc.) displayed on the display 102 to illuminate the portion 104 while leaving the portion 110 unilluminated. Such a menu may give the user options as to what portion of the display 102 to illuminate and/or the user may be able to customize a portion of the display 102 to illuminate. In some examples, when the display 102 is a touchscreen display, a user can draw on the touchscreen display to indicate a size and shape of the portion 104 to be illuminated. While a particular shaped portion 104 is illustrated in FIG. 1, other shapes may be chosen and more than one portion of the display 102 may be illuminated while remaining portions remain unilluminated.

For instance, a parent rocking a sleepy baby may be reading a news article on a tablet. The parent may desire not to wake the baby with the lighted display of the tablet. The parent can request from the controller 108 via a menu or via drawing using touch input to illuminate a particular portion (e.g., the portion 104) of the display, while leaving the remaining portion (e.g., the portion 110) unilluminated. The parent can scroll words of the news article through the illuminated portion to avoid disrupting the sleepy baby while still being able to read the news article.

In some instances, the controller 108 can identify a portion 104 (e.g., a subset of pixels) based on a pattern created by a user or an application. The controller 108 can cause certain light emitting features associated with that portion 104 to be turned on (and other light emitting features outside that area to be turned off). In examples in which the display 102 is backlit (e.g., liquid-crystal display (LCD)), the portion 104 can include a backlit portion while the portion 110 is unlit and appears black. For instance, a portion of a backlight may be energized (e.g., associated with the portion 104), while a portion of the backlight is de-energized (e.g., associated with the portion 110). In such examples, overall light emission and brightness can be reduced and power savings can be achieved.

In an example in which the display 102 includes individually illuminating pixels, cells, etc. (e.g., organic light-emitting diode (OLED), the portion 104 can include individually illuminated pixels, cells, etc. while the portion 110 includes unilluminated pixels, cells, etc. By reducing the number of illuminated pixels, cells, etc., power savings can be achieved, as well as a reduction in overall light emission and brightness in some examples.

In some instances, the memory device 106 can affect the illumination of the portion 104. For example, a portion of the memory device 106 (e.g., holographic random-access memory (HRAM), 3D XPoint™, etc.) may be powered off in proportion the unilluminated portion 110. In other examples, the memory device 106 (e.g., a multi-chip package (MCP) can be leveraged to support selective illumination. In yet other examples, a screen map or pixel map may be stored in the memory device 106 (e.g., non-volatile memory) to facilitate powering on/off portions of the display 102.

In some examples, the controller 108 can determine an active portion of the display 102 and based on that determination, illuminate the active portion (e.g., illuminated portion 104), while an inactive portion remains unilluminated (e.g., unilluminated portion 110). For instance, if a user is watching a video on a particular portion of the display 110, the controller can illuminate that particular portion (e.g., portion 104) while the remaining portion (e.g., portion 110) that is inactive remains unilluminated. As used herein, an active portion can include a portion of the display that includes movement, and/or has experienced user interaction such as swiping or tapping within a threshold period of time, among others. An inactive portion can include a portion of the display that does not include movement and/or has not experienced user interaction such as swiping or tapping within a threshold period of time, among others.

A non-limiting example may include a user swiping through pictures in a small window of a touchscreen display of a mobile device, while the remaining portion of the touchscreen display illustrates a default background screen of the touchscreen display. In such an example, the controller 108 can determine the portion including the pictures being viewed is an active portion, while the remaining portion is inactive. In response, the controller 108 can illuminate the active portion, while the inactive portion remains unilluminated.

The active portion can be determined based on an application running on the apparatus 100, in some examples. For instance, if a particular reading application is in use, a user may desire only a top portion of the display to be illuminated, and they can scroll (e.g., swipe) the words through the illuminated portion 104. For instance, in a non-limiting example, if a user is reading in bed while a spouse sleeps, he or she may desire low light output overall, but a high illumination level in the portion being read. As such, a user may request that when the particular reading application is in use, a particular portion of the display 102 is illuminated, while the remaining portion is unilluminated. This can be done without user input (e.g., upon loading the reading application the controller 108 determines the active portion without user prompts) or a user may select a prompt asking if this is a preference. For instance, upon loading the application, the controller 108 determines that the user may want to illuminate only a portion of the display 102 and may prompt the user for affirmation.

The active portion can be determined, in some instances, based on data context in the active portion. The data context, as used herein, includes the text or image within a particular portion of the display 102. For instance, in a non-limiting example, the controller 108 may determine that a video is playing in a first portion of the display 102, and an advertisement is located in a second portion of the display 102. In such an example, the controller 108 can determine that the first portion is an active portion, and the second portion is inactive. In response, the controller can illuminate the active portion and leave the inactive portion unilluminated. This can be done without user input (e.g., upon loading the video, the controller 108 determines the active portion without user prompts) or a user may select a prompt asking if this is a preference. For instance, upon loading the video, the controller 108 determines that the user may want to illuminate only a portion (e.g., the active video portion) of the display 102 and may prompt the user for affirmation.

In non-limiting examples in which the display 102 is a touchscreen display, the controller 108 can receive a request from a user to illuminate active portions of the touchscreen display. In response to the request, the controller 108 can determine an active portion or active portions of the touchscreen display and illuminate those portions. In another non-limiting example, the controller 108 can determine the active area based on a location of a touch input on the touchscreen display. For instance, the controller 108 may determine multiple active portions, and a user may touch a portion of the touchscreen display to indicate which of those determined active portions he or she desires to be the active portion to be illuminated. There may be more than one active portion and more than one illuminated portion, in some examples.

FIG. 2 is a diagram representing an example of illumination of a portion 224, 226 of a display 222 of a computing device 220 in accordance with a number of embodiments of the present disclosure. Computing device 220, for instance, may be a smartphone with a backlit touchscreen display 222. A user may decide to illuminate portions 224 and 226 of the touchscreen display 222 by drawing a particular shape with his or her finger or a digital pen, for example. The particular shape is not limited to the shapes illustrated in FIG. 2. A portion of the touchscreen display 222 that is not illuminated (e.g., portions other than 224 and 226) remain unilluminated. The user may desire to illuminate only the particular portions around videos, pictures, or particular portions of a webpage, for instance. In a non-limiting example, the illuminated portions 224 and 226 are active portions that are illuminated (e.g., without user input) upon a controller determining the portions 224 and 226 are active. Such a determination can be based on a user deeming the portions 224 and 226 active (e.g., via a menu and/or touch input), an application in use by the computing device 220 or data context in the portions 224 and 226, among others.

By illuminating a portion of the display of the computing device (e.g., portions 224 and 226) instead of the entire display 222, the computing device 220 may experience an increase in battery life and/or a reduction in power consumption. In a non-limiting example, a user may choose to illuminate a portion of the display to increase privacy (e.g., others nearby cannot see the entire display), or reduce brightness given off by the display (e.g., at night, with a resting spouse, etc.). Drawing a shape to be illuminated may be enabled on the computing device at all times or may be enabled via a menu, in some examples.

FIG. 3 is another diagram representing an example of illumination of a portion 332 of a display 322 of a computing device 330 in accordance with a number of embodiments of the present disclosure. Computing device 330, for instance, may be a smartphone with a backlit touchscreen display 322. A user may decide to illuminate portion 332 of the touchscreen display by selecting the portion from a menu. For instance, a user may choose the portion 332 based on options in the menu or may draw the portion 332 on the screen using a digital pen or his or her finger. The user may desire to illuminate only particular portions around videos, pictures, or particular portions of a webpage, for instance. The particular shape and size of the portion 332 is not limited to the shape and size illustrated in FIG. 3 and more than one portion may be selected. A portion of the touchscreen display 322 that is not illuminated (e.g., portions other than the portion 332) remains unilluminated.

In a non-limiting example, the portion 332 is illuminated as a result of controller determining an active status of the portion 332. In another non-limiting example, the portion 332 may be illuminated based on application or data context in the portion 332. For instance, the portion 332 may be deemed active based on activity in the portion 332 (e.g., scrolling book text, webpage activity, social media posts, etc.). The portion 332 may be illuminated without user input based on the activity or such settings may be customized, for instance, in the menu.

By illuminating a portion of the display of the computing device (e.g., the portion 332) instead of the entire display 322, the computing device 330 may experience an increase in battery life and/or a reduction in power consumption. In a non-limiting example, a user may choose to illuminate a portion of the display to increase privacy (e.g., others nearby cannot see the entire display), or reduce brightness given off by the display (e.g., at night, with a resting spouse, etc.).

FIG. 4 is a functional diagram representing a processing resource 450 in communication with a memory resource 442 having instructions 446, 448 stored thereon for illumination of a portion of a display of a computing device in accordance with a number of embodiments of the present disclosure. The memory device 442, in some embodiments, can be analogous to the memory device 106 described with respect to FIG. 1. The processing resource 450, in some examples, can be analogous to the controller 108 describe with respect to FIG. 1.

A system 440 can be a server or a computing device (among others) and can include the processing resource 450. The system 440 can further include the memory resource 442 (e.g., a non-transitory MRM), on which may be stored instructions, such as instructions 446 and 448. Although the following descriptions refer to a processing resource and a memory resource, the descriptions may also apply to a system with multiple processing resources and multiple memory resources. In such examples, the instructions may be distributed (e.g., stored) across multiple memory resources and the instructions may be distributed (e.g., executed by) across multiple processing resources.

The memory resource 442 may be electronic, magnetic, optical, or other physical storage device that stores executable instructions. Thus, the memory resource 442 may be, for example, a non-transitory MRM comprising Random Access Memory (RAM), an Electrically-Erasable Programmable ROM (EEPROM), a storage drive, an optical disc, and the like. The memory resource 442 may be disposed within a controller and/or computing device. In this example, the executable instructions 446 and 448 can be “installed” on the device. Additionally and/or alternatively, the memory resource 442 can be a portable, external or remote storage medium, for example, that allows the system 440 to download the instructions 446 and 448 from the portable/external/remote storage medium. In this situation, the executable instructions may be part of an “installation package”. As described herein, the memory resource 442 can be encoded with executable instructions for illumination of a portion of a display of a computing device.

The instructions 446, when executed by a processing resource such as the processing resource 450, can include instructions to receive a touch request via a touchscreen display of a mobile device to illuminate a portion of the touchscreen display. For instance, a user may issue the request via a menu of the computing device or may draw a shape directly on the touchscreen display that he or she desires to illuminate. The touch input received can include input via a finger or a digital pen, among other touch input approaches. In some examples, optional portions of the touchscreen display to illuminate can be displayed via the touchscreen display, and in response, the received touch request includes a request to illuminate one of the optional portions. For instance, a user may be presented with options as to which portion or portions of the display he or she would like illuminated, and the user can interact with the touchscreen display (e.g., touch request) to choose the desired portion or portions.

The instructions 448, when executed by a processing resource such as the processing resource 450, can include instructions to illuminate the portion of the touchscreen display while a remaining portion of the touchscreen display remains unilluminated. The illuminated portion can include a particular shape based on the shape of the touch request. For instance, a user may use a digital pen to draw a circle around a particular portion of a social media page he or she is viewing. The illuminated portion in such an example is the circle in that particular portion of the touchscreen display.

In another example, the illuminated portion is a predefined portion of the touchscreen display determined based on an application running on the mobile device or data context in the illuminated portion. For instance, when a user opens a particular application (e.g., an e-reading application), the mobile device may illuminate a particular portion of the display (e.g., without user input), a user may be prompted to choose a particular portion of the display, or a user may be given the option to illuminate a portion or the entire display. In some example, receipt of the touch request can include a request to illuminate the portion of the touchscreen display to a particular illumination level. For instance, a user can request to have particular portions illuminated to particular levels (e.g., high, medium, low, sliding scale, etc.).

In a non-limiting example with respect to data context, when a video streaming service is detected, the mobile device may illuminate (e.g. without user input) a particular portion of the display (e.g., the video streaming portion), a user may be prompted to choose a particular portion of the display, or a user may be given the option to illuminate a portion or the entire display. Other application and text contexts may be bases for the illuminated portion.

In some examples, while the portion is illuminated, an additional touch request may be received via the touchscreen display to illuminate an additional portion of the touchscreen display. For instance, a user may determine he or she would like additional text, image, video, etc. illuminated. The additional portion of the touchscreen display can be illuminated while illumination of the illuminated portion (e.g., the original illuminated portion) is retained. The touch request can be in the form of a drawing on the touchscreen display or via a menu, for example.

FIG. 5 is a flow diagram representing an example method 560 for illumination of a portion of a display of a computing device in accordance with a number of embodiments of the present disclosure. The method 560 can include, for instance, receiving a request to illuminate a portion of a display of a computing device. For instance, at 562, the method 560 includes receiving signaling via a touchscreen that indicates a portion of the touchscreen to be illuminated. In an example, a controller may receive a request to illuminate a pre-defined portion or a custom portion of the touchscreen (e.g., the display). In such an example, the computing device may be a mobile device with a lighted display (e.g., an e-reader, smartphone, tablet, etc.), and the controller can receive a request to illuminate portion A, which a user chose from a list of predefined portions (e.g., portion A, portion B, portion C, etc.) for illumination.

At 564, the method 560 can include identifying a light emitting source for each pixel bounded by the portion of the touchscreen indicated by the signaling and at 566, the method 560 can include providing power to each identified light emitting source within the portion. For instance, this can light the portion requested to be illuminated. The method 560, at 568, can include removing power from or refraining from providing power to light emitting sources outside the portion. For instance, this can apply to the area not requested to be illuminated.

In a non-limiting example where a user is using an e-reader, he or she may desire to have half of the display illuminated (e.g., so as not to disturb a sleeping spouse). This may comprise portions A and B of portions A, B, C, and D. The user may interact with the e-reader via the display (e.g., using buttons with a non-touchscreen display, using touch input with a touchscreen display, etc.) and choose from a menu which portions he or she would like illuminated. The controller receives the request upon completion of the selection.

In the same example where the user is using an e-reader, he or she may instead request a customized portion to be illuminated. This can be requested via a touch input such on a touchscreen display as a drawing on a touchscreen display in the desired shape and size. More than one customized portion may be requested. The controller receives the request upon completion of the customized request.

In another non-limiting example, a user may be using a smartphone to check bank statements. He or she may desire to have a small portion of the display illuminated (e.g., to protect privacy), and may request only portion C of a list of predefined portions be illuminated. The user may interact with the smartphone via the display (e.g., using buttons with a non-touchscreen display, using touch input with a touchscreen display, etc.) and choose from a menu which portions he or she would like illuminated. The controller receives the request upon completion of the selection.

In the same example where the user is using the smartphone, he or she may instead request a customized portion to be illuminated. This can be requested via a touch input on a touchscreen display such as a drawing on a touchscreen display in the desired shape and size. More than one customized portion may be requested. For instance, the user may draw a rectangular shape to capture daily balances to be illuminated while the remaining portions of the bank statements remain unilluminated. The controller receives the request upon completion of the customized request.

At 564, the method 560 includes illuminating, by the controller, the portion of the display while a remaining portion of the display remains unilluminated. For instance, the controller can illuminate the chosen predefined portion or portions or the customized portion or portions while leaving any other portion of the display unilluminated.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving signaling via a touchscreen that indicates a portion of the touchscreen to be illuminated;
identifying a light emitting source for each pixel bounded by the portion of the touchscreen indicated by the signaling;
providing power to each identified light emitting source within the portion; and
removing power from or refraining from providing power to light emitting sources outside the portion.

2. The method of claim 1, wherein receiving the signaling comprises receiving a request to illuminate a pre-defined portion of the touchscreen.

3. The method of claim 1, wherein the touchscreen is a display of a computing device and receiving the signaling comprises receiving a request to illuminate a pre-defined portion of the display of the computing device.

4. The method of claim 2, wherein the touchscreen is a display of a mobile device and receiving the request comprises receiving a request to illuminate a pre-defined portion of the touchscreen display.

5. The method of claim 1, wherein receiving the signaling comprises receiving the signaling via a touch input on the touchscreen.

6. The method of claim 5, wherein receiving the signaling comprises receiving a request to illuminate a particular shape drawn on the touchscreen.

7. The method of claim 1, wherein receiving the signaling comprises:
receiving a request to illuminate a plurality of portions of the touchscreen;
providing power to each identified light emitting source within each one of the plurality of portions; and
removing power from or refraining from providing power to light emitting sources each of the plurality of portions the region.

8. An apparatus, comprising:
a display;
a memory device; and
a controller coupled to the memory device configured to:
determine an active portion of the display; and
illuminate, responsive to the determination, the active portion of the display while an inactive portion of the display remains unilluminated.

9. The apparatus of claim 8, wherein the apparatus is a mobile device, and the display is a touchscreen display.

10. The apparatus of claim 8, further comprising the controller configured to determine the active portion of the display based on an application running on the apparatus.

11. The apparatus of claim 8, further comprising the controller configured to determine the active portion of the display based on data context in the active portion.

12. The apparatus of claim 8, wherein the display is a touchscreen display, and the controller is configured to determine the active portion based on a location of a touch input on the touchscreen display.

13. The apparatus of claim 8, wherein the display is a touchscreen display, and the controller is configured to determine the active portion of the touchscreen display responsive to a request received via a touch input to illuminate active portions of the touchscreen display.

14. A non-transitory machine-readable medium comprising a processing resource in communication with a memory resource having instructions executable to:
receive a touch request via a touchscreen display of a mobile device to illuminate a portion of the touchscreen display; and
illuminate the portion of the touchscreen display while a remaining portion of the touchscreen display remains unilluminated.

15. The medium of claim 14, wherein the illuminated portion is based on a shape of the touch request.

16. The medium of claim 14, wherein the illuminated portion is a predefined portion of the touchscreen display determined based on an application running on the mobile device.

17. The medium of claim 14, wherein the illuminated portion is a predefined portion of the touchscreen display determined based on data context in the illuminated portion.

18. The medium of claim 14, further comprising the instructions executable to:
receive an additional touch request via the touchscreen display to illuminate an additional portion of the touchscreen display; and
illuminate the additional portion of the touchscreen display while retaining illumination of the illuminated portion.

19. The medium of claim 14, further comprising the instructions executable to:
display via the touchscreen display, optional portions of the touchscreen display to illuminate,
wherein the received touch request includes a request to illuminate one of the optional portions.

20. The medium of claim 14, further comprising the instructions executable to receive the touch request to illuminate the portion of the touchscreen display to a particular illumination level.
